(19) United States
(12) Patent Application Publication
(10) Pub. No.: US 2006/0249216 A1
(43) Pub. Date: Nov. 9, 2006

(54) Co-injected pipe fitting

(76) Inventors: Earl H. Sexton, Elkhart, IN (US); James A. Krezel, Goshen, IN (US); Michael J. Pletcher, Goshen, IN (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/414,969

(22) Filed: May 1, 2006

Related U.S. Application Data
(60) Provisional application No. 60/677,036, filed on May 3, 2005.

(51) Int. Cl. F16L 9/14

(52) U.S. Cl. 138/141

(57) ABSTRACT

A co-injected fitting has a core made of recycled or reground PVC and ABS, which is less expensive and to which, in some embodiments, a blowing agent, such as azo and/or sodium bicarbonate, can be added to lower the weight. The fitting includes a skin on opposite sides of the core forming the internal side of the fitting and the external side of the fitting, respectively, in concentric relationship to the inner core. Such fittings may also include a strengthening core material, such as polycarbonate, to provide a stronger pipe fitting which likewise can be co-injection molded.

### CROSS-REFERENCE TO RELATED APPLICATIONS

This application claims priority under 35 U.S.C. §119(e) on U.S. Provisional Application No. 60/677,036 entitled CO-INJECTED PIPE FITTING, filed on May 3, 2005, by Earl H. Sexton, et al. +the entire disclosure of which is incorporated herein by reference.

### BACKGROUND OF THE INVENTION

The present invention relates to pipe fittings and particularly pipe fittings which can be injection molded utilizing co-injection of different polymeric materials.

Pipe fittings include elbows, T-s, couplings, and the like, which are employed for transmitting fluids in conduits and coupling conduits in flow systems. The use of thermoplastic materials to injection mold such fittings is well known. The conventional methods of producing composite pipe joints include the use of thermoset materials and multiple production steps resulting in a composite pipe fitting or pipe section comprised of multiple layers of thermoset and/or thermoplastic materials. The cost of pipe fittings utilizing polymeric materials, such as PVS and ABS, and particularly pipe fittings which are 1- 1/2″ or larger in diameter can be somewhat expensive due to the cost of virgin raw materials. Additionally, relatively large fittings can be somewhat bulky and heavy.

### SUMMARY OF THE INVENTION

There is a need, therefore, for pipe fittings which can be injection molded and which can employ an inner core which is either inexpensive, lighter in weight, or which has characteristics which improve the structural characteristics of the fittings. Such inner cores can be surrounded by a skin of conventional polymeric material, such as PVC and/or ABS.

The system of the present invention provides such a product by the process of co-injection molding a core made of recycled or reground PVC and ABS, which is less expensive and to which, in some embodiments, a blowing agent, such as azo and/or sodium bicarbonate, can be added to lower the weight. The fitting includes a skin on opposite sides of the core forming the internal side of the fitting and the external side of the fitting, respectively, in concentric relationship to the inner core. Such fittings may also include a strengthening core material, such as polycarbonate, to provide a stronger pipe fitting which likewise can be co-injection molded.

This invention discloses a composite pipe joint comprised of three layers of thermoplastic material and produced by co-injection molding in a single mold in a single operation. This invention resolves issues with earlier technologies including scrap reclaim issues associated with the use of thermoset materials, elimination of resin cure time, the ability to use existing production tooling and production of composite pipe joints without the need of secondary operations.

These and other features, objects and advantages of the present invention will become apparent upon reading the following description thereof together with reference to the accompanying drawings.

### BRIEF DESCRIPTION OF THE DRAWINGS

FIG. 1 is a schematic view of a co-injection machine and die which provide the structure and process for manufacturing fittings according to this invention;

FIG. 2 is a cross-sectional view of a T-pipe fitting embodying the present invention;

FIG. 3 is an enlarged, fragmentary, cross-sectional view of a pipe fitting incorporating a first embodiment of the present invention;

FIG. 4 is an enlarged, fragmentary, cross-sectional view of a pipe fitting incorporating a second embodiment of the present invention; and

FIG. 5 is an enlarged, fragmentary, cross-sectional view of a pipe fitting incorporating a third embodiment of the present invention;

### DETAILED DESCRIPTION OF THE PREFERRED EMBODIMENT

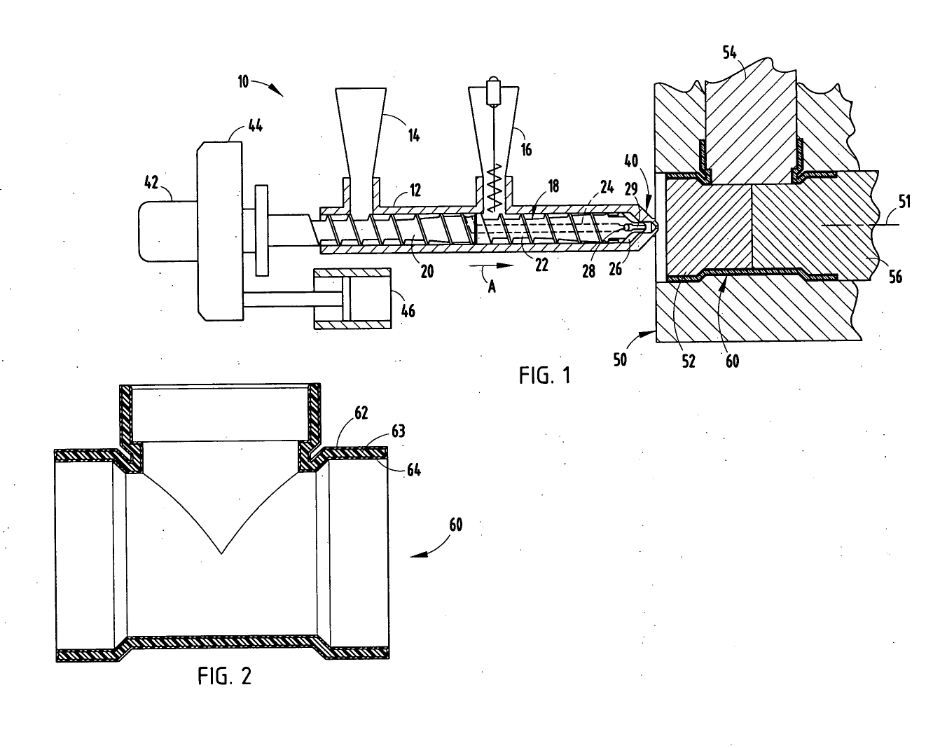

Referring initially to FIG. 1, there is shown a, schematic view of an injection molding machine 10 which is employed in the co-injection of pipe fittings according to the present invention. The machine is commercially available and manufactured by Spirex Corporation and identified as a Twinshot co-injection design barrel and screw. In FIG. 1, there is shown a schematic diagram of such a machine 10 which includes a barrel 12 with a first feed hopper 14 and a second feed hopper 16. The first feed hopper 14 carries the material which is employed to inject the skin layers of a fitting according to the present invention, while the second feed hopper 16 includes the material which forms the core of the fittings.

The injector 10 includes a dual feed screw 18 with a first thread flight 20 and a second thread flight 22 for carrying polymeric material from feed hoppers 14 and 16 inside barrel 12 to convert it to a fluid form. A conduit 24 (shown in phantom in FIG. 1) allows the material from hopper 14 to exit the injector nozzle 40 while a second conduit 26 allows the material from hopper 16 to coaxially exit injector nozzle 40. Check valve 28 prevents material from reentering the threaded sections 20, 22. The screw 18 conveys material from the first hopper in a first plasticizing zone past the second threaded section 22 of screw 18 through the conduit 24 and into opening 29 at the center of the injector 40. Simultaneously, the second screw section 22, which plasticizes material in hopper 16 in the plasticizing zone along its length, conveys the second melt through opening 26 behind and to the periphery of the melt from conduit 24. Screw 18 is rotatably driven by a motor 42 coupled by a longitudinally movable platen 44 to the screw 18. Motor 42 is a high torque and relatively low rotational speed motor. The injection platen is controlled by a hydraulic cylinder 46 to inject the two different materials into a die 50 with the nozzle 40 in engagement with the gate of the die or mold 50. In the embodiment shown, the die is in the form of a pipe fitting to be co-injected.

The co-injection process advances screw 28 as seen in FIG. 1 with the molten skin material from hopper 14 first being injected into the mold 50 to coat the inner surfaces of the mold with the polymeric skin. As the screw is further advanced in a direction indicated by arrow A in FIG. 1, the core material is injected into mold 50 in the remaining open space forming the core area of the fitting being molded. The injector 10 and its operation is disclosed in greater detail in U.S. Pat. No. 7,004,739, the disclosure of which is incorporated herein by reference.

In summarizing, the steps for producing a composite thermoplastic pipe joint using this co-injection molding process include:
a) The skin layers material is loaded into the molding machine rear hopper 14.
b) The rear section 20 of the processing screw 18 melts and processes this skin material. The material is pushed down the screw where a dam located at the mid-point of the screw forces the material to flow into a hollow section 24 running along the interior of the screw to the material accumulation chamber 26 located at the screw tip.
c) Simultaneously, the core layer material is loaded into the molding machine forward hopper 16.
d) The forward section 22 of the processing screw 18 melts and processes the core material and pushes it to the material accumulation chamber 26 located at the screw tip or nozzle 40. At this time, the accumulation chamber contains pools of both skin and core materials with the skin material closer to the nozzle.
e) Both skin and core materials are then subsequently injected into the mold 50 forming the part 60 by the actuation of cylinder 46, which advances screw 18 to the position shown in FIG. 1. Laminar flow of the two materials assures that the skin material flows to and forms the skin layers 62 and 64 of the composite pipe fitting 60 and the core material flows to the core layer 63 of the fitting.

Mold 50 includes a die cavity 52 which defines the inner and outer shape of a fitting 60 to be co-injected within the mold. Mold 50 may be a single cavity mold for relatively large parts or, as indicated by the dotted lines 51, may be extended for up to 12 to 16 cavities for smaller parts. The mold itself is of conventional construction including a gate which mates with nozzle 40 and suitable mold inserts, such as 54 and 56, which define the interior walls of the fitting to be molded. During the injection process, the skin material from hopper 14 first coats the inner surfaces of mold cavity 62 and the outer surfaces of the inserts 54 and 56 with a thickness as described below, leaving an open area in the mold between the skin surfaces so defined. As screw 18 is further advanced, the now molten core material from hopper 16 is then injected into the mold cavity to fill the core area between the skins.

Referring now to FIG. 2, there is shown a composite pipe fitting 60 comprised of three distinct layers. The outer and inner skin layers 62 and 64 are comprised of the same thermoplastic material acceptable for use in drainage, flow control, or potable water applications including polyvinyl chloride (PVC), acrylonitrile-butadiene-styrene (ABS), chlorinated polyvinyl chloride (CPVC), polypropylene (PP), polyethylene (PE), polyvinylidene fluoride (PVDF), or nylon (PA). The core layer 63 can be any thermoplastic material compatible with the skin layer material and capable of bonding to it through cohesion.

The preferred embodiment is that the skin layers 62 and 64 material be of the same family of thermoplastic material used in an adjoining pipe to which the fitting may be attached, allowing use of existing and proven joining technologies. The core layer 63 is any thermoplastic material compatible with the skin layers 62 and 64 material and which is capable of bonding to it through cohesion without the use of adhesives. The core layer 63 material can be selected to reduce the cost of the resulting fitting or to enhance its performance properties.

The preferred embodiment is that the core layer 63 material can be of any of a family of cellular (foam) thermoplastic materials. These cellular materials can be produced through the use of chemical blowing agents or the direct addition of gas to the thermoplastic melt in the injection molding machine. These cellular materials can be of the same thermoplastic family as the skin layers material or any thermoplastic material compatible with the skin layers material and capable of bonding to it through cohesion.

Another option for the core layer material 63 is to use post-industrial and/or post-consumer thermoplastic recycle materials. These recycle materials may be of the same family of thermoplastic material as the skin layers material or any thermoplastic material compatible with the skin layers material and capable of bonding to it through cohesion.

A third option for the core layer material 63 is to use a modified and/or reinforced thermoplastic material. These materials may be of the same family of thermoplastic material used in the skin layers or any thermoplastic material compatible with the skin layers material and capable of bonding to it through cohesion. Examples of modified and/or reinforced materials include:
a) A thermoplastic material having increased heat distortion temperature. Use of this type of material in the core layer would form a composite pipe fitting having increased temperature resistance.
b) A thermoplastic material reinforced to have increased strength and/or stiffness. Use of this type of material in the core layer would form a composite pipe joint having increased strength allowing a reduction in the pipe fitting wall thickness without sacrificing performance. Reinforcing agents include any of the mineral, glass or natural or manmade fiber fillers known to increase the strength and stiffness of thermoplastic materials.

Thus, this invention envisions a composite pipe fitting, such as 60 in FIG. 2, which is comprised of three thermoplastic layers as described above formed through co-injection molding. Co-injection molding of thermoplastic materials offers many advantages over existing known technologies of producing composite fittings using thermoset materials. These advantages include the ability to reuse scrap from the co-injection process, reduction of manufacturing time through the elimination of the cure time necessary with thermoset materials and reduction of manufacturing costs through the elimination of secondary operations.

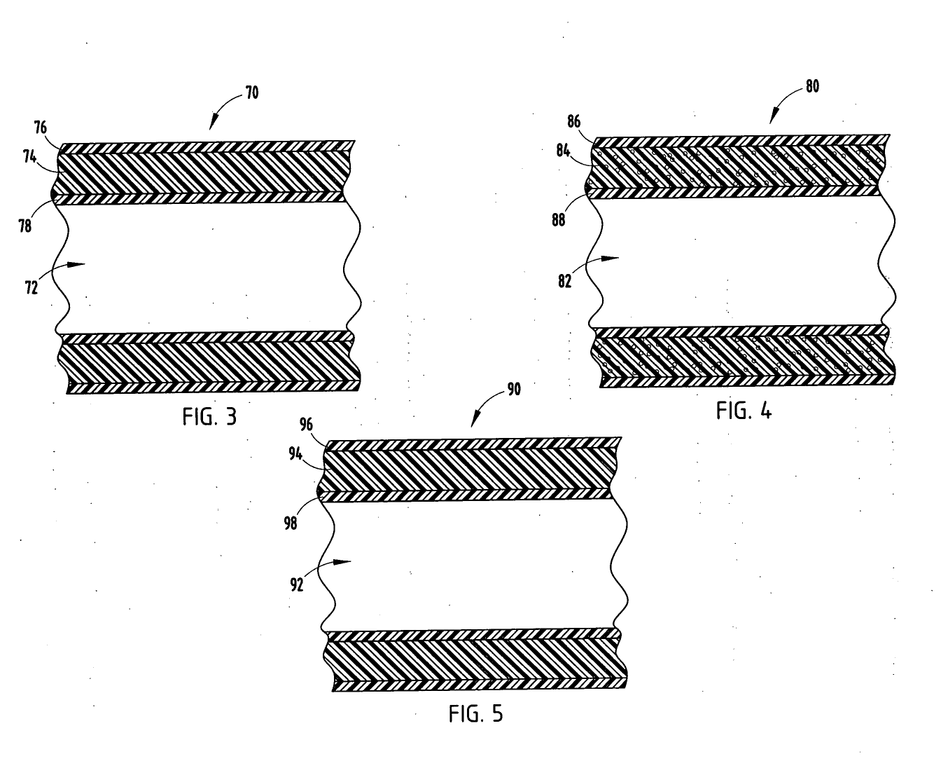

Referring now to FIG. 3, there is shown a pipe fitting 70 which can be a T, an elbow, a coupling, a conduit, or any other form of a pipe fitting designed to conduct a fluid therethrough. In each of the examples of FIGS. 3-5, a pipe fitting fragmentary cross section is shown, it being understood that the actual fitting will be a standard coupling, elbow, T, pipe section, or the like. The pipe fitting of FIG. 3 has a central, generally cylindrical opening 72 and is co-injection molded with a central core 74 surrounded by an outer skin 76 and an inner skin 78. In the embodiment shown, the outer and inner skins, 76 and 78 respectively, are made of a virgin polymeric material, as described above including PVC or ABS, while the inner core 74 can be made of recycled, reground PVC or ABS, which is significantly less expensive. The fitting 70 can be molded utilizing co-injection equipment and method described above. This manufacturing process provides the following benefits:
Reduce resin costs by 25 percent or more;
Make use of off-spec and regrind materials;
Encapsulate a lower-cost resin within a higher-cost UV stabilized resin;
Use less energy;
Enjoy simpler set-up and lower operational complexity;
Reduce maintenance costs;
Use less floor space;
Use a nozzle configuration that is completely standard; and
Easily convert back to single-material mode (supply the same material to both feed hoppers).

In the embodiment of FIG. 4, a pipe fitting 80 is provided which includes a central conduit 82 defined by an inner skin 88 of a polymeric material, such as virgin PVC or ABS or the like, a core 114, which also can be made of recycled, reground ABS and/or PVC or other suitable material, to which a foaming or blowing agent has been added, such as azo and/or sodium bicarbonate to provide a lighter weight and yet significantly strong inner core which is surrounded during the co-injection process by an outer skin 86 also made of a virgin PVC or ABS material. The relative thickness of the inner core 74 of FIG. 3 and 84 of FIG. 4, is about four times that of the inner and outer skins and, for a 2 inch diameter fitting, for example, the inner core 74, 84 may have a thickness of about 0.080″ while the skins 76, 78, 86 and 88, respectively, have a thickness of about 0.020″. For different sized pipes, these dimensions will vary with, for example, in a four inch pipe, the inner core may have a thickness of about 0.140″ while the skin's thickness may be increased to about 0.030 inches.

FIG. 5 shows yet another embodiment of the invention in which a pipe fitting 90 includes an inner conduit 92 having an inner skin 98, a central core 94, and an outer skin 96. The inner core 94 of this embodiment of the invention is also a co-injection polymeric material but one which adds a structural characteristic different than that of the first and second embodiments. Thus, the polymeric material used for inner core 94 may be polycarbonate or some other co-injectable material which adds greater strength to the fitting for more rigorous applications.

It will become apparent to those skilled in the art that various modifications to the preferred embodiments of the invention as described herein can be made without departing from the spirit or scope of the invention as defined by the appended claims.

The invention claimed is:

1. A co-injected pipe fitting including:
an inner skin of a first material and an outer skin of said first material; and
said inner and outer skins co-injected with a core concentric with said inner and outer skins and made of a second material different than said first material.

2. The pipe fitting as defined in claim 1 wherein said first and second materials are polymeric materials.

3. The pipe fitting as defined in claim 1 wherein said first material is one of PVC or ABS.

4. The pipe fitting as defined in claim 3 wherein said second material is one of recycled PVC or ABS.

5. The pipe fitting as defined in claim 4 wherein said second material includes a foaming agent.

6. The pipe fitting as defined in claim 5 wherein said foaming agent is one or both of azo and bicarbonate of soda.

7. The pipe fitting as defined in claim 3 wherein said second material is polycarbonate.

8. The pipe fitting as defined in claim 1 wherein said core has a thickness about four times greater than that of either of said inner and outer skins.

9. A composite pipe joint comprising three layers of at least two different thermoplastic materials formed through co-injection molding.

10. A thermoplastic composite pipe joint as defined in claim 9 wherein the co-injection molding uses a single injection molding machine including a screw and barrel for simultaneously melting, processing, and injecting two materials in separate layers.

11. A thermoplastic composite pipe joint as defined in claim 10 wherein the thermoplastic material layers are bonded to each other through cohesion.

12. A thermoplastic composite pipe joint as defined in claim 9 wherein inner and outer skin layers are comprised of a first thermoplastic material and a core layer is comprised of a second thermoplastic material compatible with said first material and capable of bonding to it though cohesion.

13. A thermoplastic composite pipe joint as defined in claim 12 wherein the skin layers are comprised of any of a family of thermoplastic materials acceptable for use in drainage, flow control, or potable water applications, including polyvinyl chloride (PVC), acrylonitrile-butadiene-styrene (ABS), chlorinated polyvinyl chloride (CPVC), polypropylene (PP), polyethylene (PE), polyvinylidene fluoride (PVDF) or nylon (PA).

14. A thermoplastic composite pipe joint as defined in claim 12 wherein said first material is one of the family of materials used in the adjoining pipe allowing use of existing joining technologies.

15. A thermoplastic composite pipe joint as defined in claim 12 wherein said second material is any of a family of cellular (foam) thermoplastic materials compatible with said first material used in the skin layers and capable of bonding to said first material through cohesion.

16. A thermoplastic composite pipe joint as defined in claim 12 wherein said second material is any of a family of post-industrial or post-consumer recycle thermoplastic materials compatible with said first material used in said skin layers and capable of bonding to said first material through cohesion.

17. A thermoplastic composite pipe joint as defined in claim 12 wherein said second material is any of a family of modified or reinforced thermoplastic materials compatible with said first material used in said skin layers and capable of bonding to said first material through cohesion, wherein said second material may include increased strength, increased stiffness, and/or increased heat deflection temperature to improve the performance of said fitting.

18. A thermoplastic composite pipe joint as defined in claim 12 wherein said first thermoplastic material used in said inner and outer layers is any of a family of rigid polyvinyl chloride (PVC) materials acceptable for use in drainage, flow control, or potable water applications.

19. A thermoplastic composite pipe joint as defined in claim 18 wherein said second thermoplastic material used in said core layer is any cellular (foam) thermoplastic material compatible with polyvinyl chloride (PVC) and capable of bonding to said first material through cohesion.

20. A thermoplastic composite pipe joint as defined in claim 19 wherein said second thermoplastic material used in said core layer is any post-industrial or post-consumer recycle thermoplastic material compatible with polyvinyl chloride (PVC) and capable of bonding to said first material through cohesion.

21. A thermoplastic composite pipe joint as defined in claim 18 wherein said second thermoplastic material used in said core layer is any modified or reinforced thermoplastic material compatible with polyvinyl chloride (PVC) and cable of bonding to said first material through cohesion, wherein said second material may include increased strength, increased stiffness, and/or increased heat deflection temperature to improve the performance of said fitting.

22. A thermoplastic composite pipe joint as defined in claim 12 wherein said first thermoplastic material used in said skin layers is any of a family of acrylonitrile-butadiene-styrene (ABS) materials acceptable for use in drainage, flow control, or potable water applications.

23. A thermoplastic composite pipe joint as defined in claim 12 wherein said second thermoplastic material used in said core layer is any cellular (foam) thermoplastic material compatible with acrylonitrile-butadiene-styrene (ABS) material and capable of bonding to said first material through cohesion.

24. A thermoplastic composite pipe joint as defined in claim 12 wherein said second thermoplastic material used in said core layer is any post-industrial or post-consumer recycle thermoplastic material compatible with acrylonitrile-butadiene-styrene (ABS) material and capable of bonding to said first material through cohesion.

25. A thermoplastic composite pipe joint as defined in claim 12 wherein said second thermoplastic material used in said core layer is any modified or reinforced thermoplastic material compatible with acrylonitrile-butadiene-styrene material and capable of bonding to said first material through cohesion, wherein said second material may include increased strength, increased stiffness, and/or increased heat deflection temperature to improve the performance of said fitting.

26. A method of forming a composite pipe fitting comprising:
introducing a first material into a hopper of a co-injection machine;
introducing a second material into a hopper of a co-injection machine; and
placing a die in the shape of a pipe fitting in communication with said co-injection machine such that said first and second materials are co-injected into said die to form said pipe fitting.

27. The method as defined in claim 26 wherein said first material is one of PVC or ABS.

28. The method as defined in claim 27 wherein said second material is one of recycled PVC or ABS.

29. The method as defined in claim 28 wherein said second material includes a foaming agent.

30. The method as defined in claim 26 wherein said co-injection results in a pipe fitting having outer and inner skins coaxially surrounding a core.

31. The method as defined in claim 30 wherein said core has a thickness about four times greater than that of either said inner and outer skins.

32. A pipe fitting made by the process of co-injecting different materials into a mold, said fitting comprising:
an inner skin of a first material;
an outer skin of said first material; and
a core concentric with said inner and outer skins and made of a second material different than said first material.

33. The pipe fitting as defined in claim 32 wherein said first and second materials are polymeric materials.

34. The pipe fitting as defined in claim 32 wherein said first material is one of PVC or ABS.

35. The pipe fitting as defined in claim 34 wherein said second material is one of recycled PVC or ABS.

36. The pipe fitting as defined in claim 35 wherein said second material includes a foaming agent.

37. The pipe fitting as defined in claim 36 wherein said foaming agent is one or both of azo and bicarbonate of soda.

38. The pipe fitting as defined in claim 32 wherein said second material is polycarbonate.

39. The pipe fitting as defined in claim 32 wherein said core has a thickness about four times greater than that of either of said inner and outer skins.
